(19) United States
(12) Patent Application Publication
(10) Pub. No.: US 2025/0088160 A1
(43) Pub. Date: Mar. 13, 2025

(54) DATA PROCESSING AND ELECTRONICS MANAGEMENT IN MULTI-ZONE AUDIO AMPLIFIERS

(71) Applicant: JUKE AUDIO INC., Manhattan Beach, CA (US)

(72) Inventors: John Bradford Forth, Rio Grande, PR (US); Yutong GU, Los Angeles, CA (US); Bradford Colton Forth, Manhattan Beach, CA (US); Jerry Woods, PITTSBURGH, PA (US)

(21) Appl. No.: 18/829,130

(22) Filed: Sep. 9, 2024

Related U.S. Application Data
(60) Provisional application No. 63/537,159, filed on Sep. 7, 2023.

(51) Int. Cl. H03F 3/68; H04R 3/12; H04R 5/04

(52) U.S. Cl. CPC H03F 3/68; H04R 3/12; H04R 5/04; H04R 2420/07

(57) ABSTRACT

According to an aspect of an embodiment, a multi-zone audio amplifier may include an audio manager, a data bus, and multiple amplifiers coupled to the data bus. The audio manager may obtain audio inputs representative of sound to be played at an audio output device, from an audio source via a network. The multiple amplifiers may provide audio outputs representative of the sound to multiple zones, each zone corresponding to one or more different audio output device for playback of the sound. The multiple amplifiers may receive the audio inputs from the audio manager via the data bus.

### CROSS-REFERENCE TO RELATED APPLICATIONS

This patent Application claims priority to U.S. Provisional Application No. 63/537,159 filed Sep. 7, 2023, which is incorporated herein by reference in its entirety.

### FIELD

The embodiments discussed in the present disclosure are related to multi-zone audio amplifiers.

### BACKGROUND

A building or home may include multiple zones or rooms that include separate audio output devices such as speakers. An audio system may be used to output different audio inputs at the different audio output devices. The audio system may include devices that receive the audio inputs and provide amplification to drive the audio output devices. As a number of the zones increase, multiple amplifiers or devices that provide amplification may be used to provide amplification to the audio output devices.

The subject matter claimed herein is not limited to embodiments that solve any disadvantages or that operate only in environments such as those described above. Rather, this background is only provided to illustrate one example technology area where some embodiments described herein may be practiced.

### SUMMARY

According to an aspect of an embodiment, a multi-zone audio amplifier may include an audio manager, a data bus, and amplifiers coupled to the data bus. The audio manager may obtain audio inputs representative of sound to be played by an audio output device (e.g., a speaker), from an audio source via a network. The amplifiers may provide audio outputs representative of the sound to multiple zones. In some embodiments, each zone may correspond to a different audio output device to play the sound. The amplifiers may receive the audio inputs from the audio manager via the data bus.

The object and advantages of the embodiments will be realized and achieved at least by the elements, features, and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 illustrates a block diagram of an example environment that includes a multi-zone amplifier to route audio inputs to multiple audio zones;

FIG. 2 illustrates the multi-zone audio amplifier of FIG. 1 connected to multiple audio zones to route the audio inputs to the multiple zones;

FIG. 3 illustrates an example packet sent by an embedded computing device or a field programmable gate array (FPGA) of the multi-zone audio amplifier of FIG. 1;

FIG. 4 illustrates a flow chart of an example method of routing different audio inputs to audio zones; and

FIG. 5 illustrates a block diagram of an example computing system that may be used with the multi-zone audio amplifier of FIG. 1;

All in accordance with one or more embodiments of the present disclosure.

### DESCRIPTION OF EMBODIMENTS

A multi-zone audio system may be used to simultaneously provide various audio output to different zones (e.g., areas) of a building or home. The multi-zone audio system may permit a single instance of audio content to be provided to multiple zones and/or permit different audio outputs to be provided separately to multiple zones concurrently.

Systems exist today that provide audio outputs to numerous zones in buildings or homes. However, these systems consist of devices that receive audio input from a variety of audio sources and provide amplification of the audio outputs to drive audio output devices. For systems in which the audio output devices are wired to a central location, the systems are complex to install and require the connection and/or configuration of a variety of components. Additionally, these wired systems may consume significant amounts of power and generate a lot of heat. These systems typically use analog signal processing between the audio sources and the audio output devices to select audio sources and relative volume levels for each of the zones. Some systems use wireless speakers or distributed amplifiers, which require their own power supplies, enclosures, signal processing and network interfaces.

According to one or more embodiments of the present disclosure, a multi-zone audio amplifier may receive multiple audio inputs and route the audio inputs to multiple zones, each of the zones includes an audio output device, such as a speaker. The multi-zone audio amplifier may receive and process multiple audio inputs and provide the audio inputs to an amplifier such that the audio inputs may be provided to the audio output device at an amplified level. As described in detail in the present disclosure, the multi-zone audio amplifier may provide the audio inputs to multiple amplifiers using a single data bus. Such implementations allow the multi-zone audio amplifier to be cost-effective and to perform central management of the audio outputs.

These and other embodiments of the present disclosure will be explained with reference to the accompanying figures. It is to be understood that the figures are diagrammatic and schematic representations of such example embodiments, and are not limiting, nor are they necessarily drawn to scale. In the figures, features with like numbers indicate like structure and function unless described otherwise.

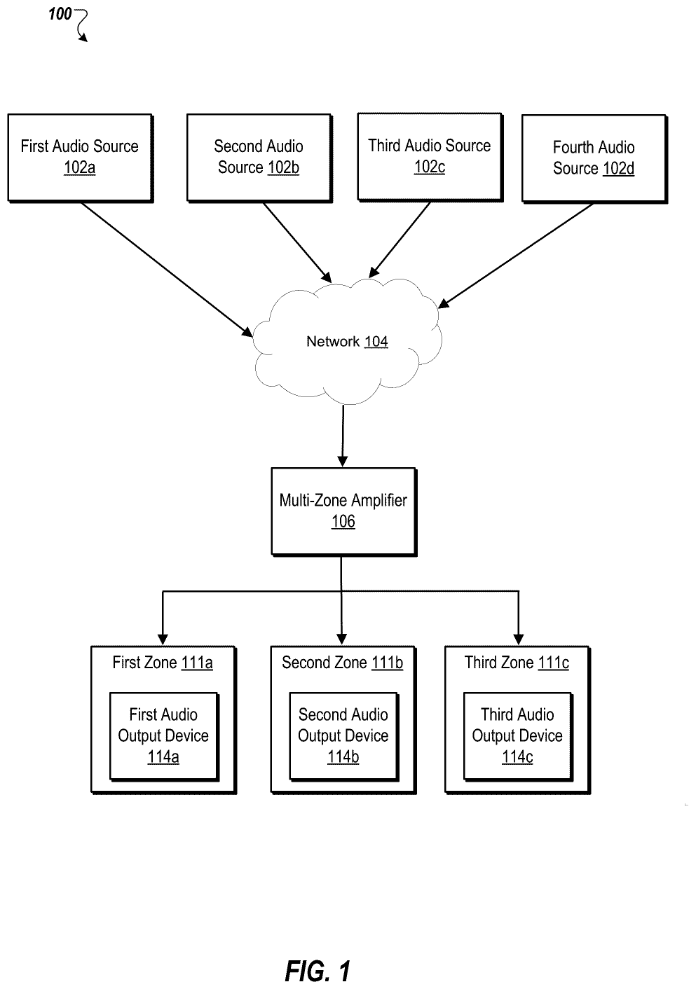

FIG. 1 illustrates an example environment 100 that includes a multi-zone amplifier 106 (“audio amplifier 106”) to route audio inputs to multiple audio zones 111a-c, in accordance with one or more embodiments of the present disclosure. The audio amplifier 106 may receive the audio inputs from multiple audio sources. For example, the audio amplifier 106 may receive the audio inputs from a first audio source 102a, a second audio source 102b, a third audio source 102c, or a fourth audio source 102d (collectively referred to as “audio sources 102”).

The audio sources 102 may include devices that are connected to the audio amplifier 106 via a network 104. For example, the audio sources 102 may include tablets, computers, smart phones, or any other appropriate wired device or wireless device. Although four audio sources 102 are illustrated, any number of audio sources or devices may be used in association with the audio amplifier 106. For example, more or fewer audio sources 102 may be used in association with the audio amplifier 106.

The network 104 may include any suitable type of network such as a local area network (LAN), a wide area network (WAN), a metropolitan area network (MAN), a personal area network (PAN), a campus area network (CAN), a storage area network (SAN), a wireless local area network (WLAN), a cellular network, a satellite network, or any other network which may receive the audio inputs from the audio sources 102 and provide the audio inputs to the audio amplifier 106. In some embodiments, the network 104 may include a Bluetooth network, Wi-Fi, and Ethernet, although other less common connection methods may also be used.

In some embodiments, the audio inputs may correspond to audio data files representative of songs stored in a digital format, audio recordings created or stored by the audio sources 102, among others. Additionally or alternatively, the audio inputs may represent any audio streaming at the audio sources 102, such as YouTube videos and other multimedia contents from the Internet. The audio sources 102 may receive the audio inputs via online sources or platforms such as Apple Music, Spotify, or any other audio stream providing services or applications that may be operating on the audio sources 102. The audio sources 102 may provide the audio inputs to the audio amplifier 106 via the network 104.

The audio amplifier 106 may route the audio inputs to the different zones 111a-c. For example, the audio amplifier 106 may route the audio inputs to a first zone 111a, a second zone 111b, or a third zone 111c (collectively referred to as “zones 111”). Although three zones 111 are illustrated, the audio amplifier 106 may be associated with any suitable number of zones. In the present disclosure, the zones 111 may include physical locations, such as different rooms in a building or a home, different buildings, or any other appropriate physical location. Each of the zones 111 may include audio output devices 114a-c. For example, the first zone 111a may include a first audio output device 114a, the second zone 111b may include a second audio output device 114b, and the third zone 111c may include a third audio output device 114c. Examples of the audio output devices 114a-c include speakers, headphone, soundbars, sub-woofers, audio transducers, or any appropriate device configured to play sounds based on the audio inputs.

The audio amplifier 106 may route the audio inputs from the audio sources 102 to the zones 111 in various manners. For example, the audio amplifier 106 may route the audio inputs so that each of the zones 111 receives a different audio input. In another example, the audio amplifier 106 may route the audio inputs so that at least two of the zones 111 receive the same audio input.

Modifications, additions, or omissions may be made to the environment 100 without departing from the scope of the present disclosure. For example, in some embodiments, the environment 100 may include any number of other components that may not be explicitly illustrated or described.

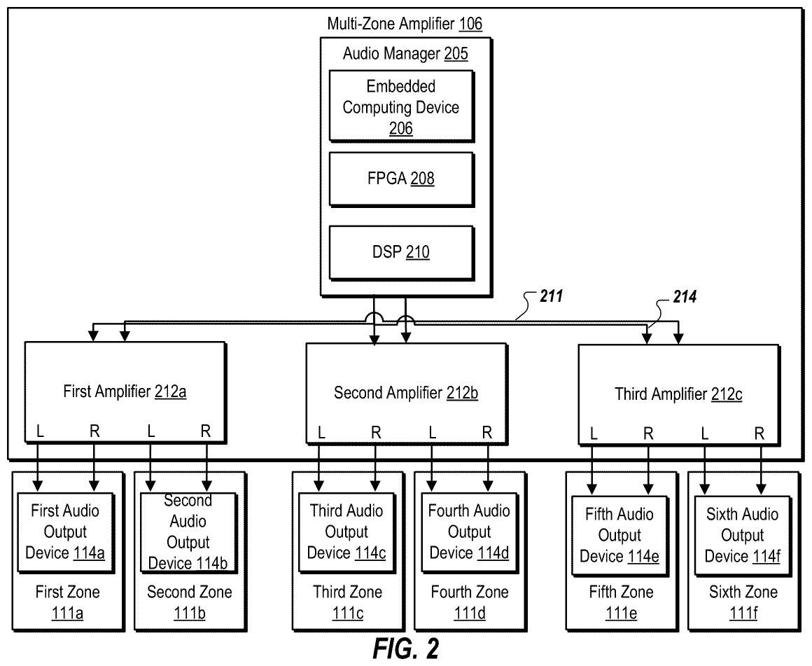

FIG. 2 illustrates the multi-zone amplifier 106 of FIG. 1 connected to multiple audio zones 111a-f to route the audio inputs to the multiple zones 111a-f, in accordance with one or more embodiments of the present disclosure. The audio amplifier 106 may include an audio manager 205 and amplifiers 212a-c. For example, the audio amplifier 106 may include a first amplifier 212a, a second amplifier 212b, or a third amplifier 212c (collectively referred to as “the amplifiers 212”). In some embodiments, the audio manager 205 may communicate with the amplifiers 212 via a data bus 211.

The audio manager 205 may include code and routines configured to enable an embedded computing device 206, an FPGA 208, or a digital signal processor (DSP) 210 of the audio amplifier 106 to perform one or more operations with respect to routing the audio inputs to the zones 111a-f Additionally or alternatively, the audio manager 205 may be implemented using hardware including a processor, a microprocessor (e.g., to perform or control performance of one or more operations), an FPGA, or an application-specific integrated circuit (ASIC). In some other instances, the audio manager 205 may be implemented using a combination of hardware and software. In the present disclosure, operations described as being performed by the audio manager 205 may include operations that the audio manager 205 may direct the embedded computing device 206, the FPGA 208, or the DSP 210 to perform.

The embedded computing device 206 may include a computing device or a processor configured to process the audio inputs. For example, the embedded computing device 206 may include a microprocessor, microcontroller, an FPGA, a DSP, a Raspberry Pi Module, among others. In some embodiments, the embedded computing device 206 may include multiple processors linked together to facilitate distribution and processing of the audio inputs.

The audio manager 205 may obtain the audio inputs from one or more audio sources (e.g., the audio sources 102 of FIG. 1) via a network (e.g., the network 104 of FIG. 1) and may route the audio inputs to one or more of the zones 111a-f. For example, the embedded computing device 206 may obtain the audio inputs from the audio sources 102 via the network 104 of FIG. 1. In some embodiments, the embedded computing device 206 may simultaneously receive multiple audio inputs from different audio sources. In other embodiments, the embedded computing device 206 may receive one audio input from a single audio source.

In some embodiments, the embedded computing device 206 may receive the audio inputs wirelessly. For example, the network 104 of FIG. 1 may include a wireless network and the audio sources 102 may provide the audio inputs using wireless inputs such as Airplay2, Spotify Connect, DLNA, Bluetooth, among others. In other embodiments, the embedded computing device 206 may receive the audio inputs via a wired connection. For example, the network 104 of FIG. 1 may include a wired network and the audio sources 102 may provide the audio inputs via a Radio Corporation of America (RCA) cable, a universal serial bus (USB) cable, an Ethernet cable among others.

In some embodiments, the embedded computing device 206 may process the audio inputs and provide digital representations of the audio inputs to the FPGA 208 (referred to in the present disclose as “digital representations”). The embedded computing device 206 may communicate with the FPGA 208 using a serial communication bus, such as a serial peripheral interface (SPI) bus or any other appropriate bus. In some embodiments, the embedded computing device 206 may communicate with the FPGA 208 using packets that represent the digital representations.

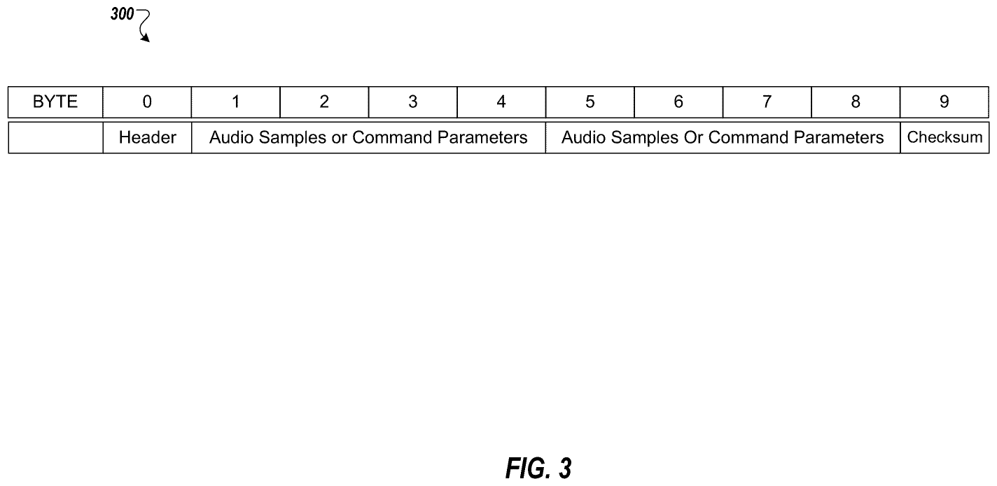

In some embodiments, the embedded computing device 206 may communicate with the FPGA 208 using packets. For example, the embedded computing device 206 may send a packet that includes ten bytes of data to the FPGA 208 and receive a packet that includes ten bytes of data from the FPGA 208. Referring to FIG. 3, a packet 300 including ten bytes of data to be sent between the embedded computing device 206 and the FPGA 208 is shown.

In some embodiments, a first and/or a most significant byte of the packet 300 (labelled “0” in FIG. 3) may include a header. The header may identify content of a subsequent set of bytes of the packet 300 (e.g., a second byte through a fifth byte (labelled “1”, “2”, “3”, and “4” in FIG. 3) of the packet 300). For example, the first byte of the packet 300 may identify the content of the second byte through the fifth byte of the packet 300 as being the digital representations or commands such as instructions.

In some embodiments, a first bit of the first byte of the packet 300, when sent by the embedded computing device 206, may indicate whether that the subsequent set of bytes of the packet 300 includes the digital representations or commands. In instances in which the first bit of the first byte of the packet 300 indicates that the subsequent set of bytes of the packet includes the digital representations, a subsequent set of bits of the first byte (e.g., a second bit to a fourth bit) of the packet 300 may indicate which audio inputs of the multiple audio inputs that the digital representations originate.

In instances in which the first bit of the first byte of the packet 300 indicates that the following bytes include the commands, the subsequent set of bits of the first byte may indicate a type of the commands. For example, the subsequent set of bits of the first byte of the packet 300 may indicate that the types of the commands are one or more of a mapping command (e.g., a command to update a routing matrix of one or more of the audio inputs), a light emitting diode (LED) command (e.g., a command to change a blinking pattern of an LED), a volume command (e.g., a command to adjust a volume), a tone command (e.g., a command to change a generated tone), among others.

A remaining four bits (e.g., a fifth bit to an eighth bit) of the first byte of the packet 300 may specify the same information as the first four bits (e.g., the first bit to the fourth bit) but with respect to a sixth byte to a ninth byte (labelled “5”, “6”, “7”, and “8” in FIG. 3) of the packet 300. For example, the fifth bit of the first byte of the packet 300 may indicate whether the sixth byte through ninth byte of the packet 300 include the digital representations or commands, and the sixth bit through the ninth bit of the first byte of the packet 300 may indicate from which audio inputs of the multiple audio inputs the audio inputs originate or a type of the commands based on the fifth bit of the first byte of the packet 300.

In some embodiments, the digital representations in the second byte through the fifth byte of the packet 300 and/or in the sixth byte through the ninth byte of the packet 300 may be in a form of a sixteen bit two channel audio pulse-code modulation (PCM) sample. In embodiments in which the various bytes of the packet 300 include the commands, the commands may vary based on the command type. For example, a mapping command may allocate a last byte and a second-to-last byte of the corresponding set of bytes (e.g., the fourth byte and the fifth byte) of the packet 300 may indicate an audio input and a zone are to be mapped.

In some embodiments, a tenth byte of the packet 300 may include a checksum generated based on the first byte to the ninth byte. The checksum may offer error detection of the first nine bytes of the packet 300. For example, the checksum may indicate whether data corruption of the packet 300 occurred during data transmission. In some embodiments, any suitable type of checksum or error detection may be used. For example, the checksum may include a cyclic redundancy check eight (CRC-8) used to detect errors in digital data.

Although the packet 300 is illustrated as including ten bytes, any other suitable format or number of bytes may be used. For example, the packet 300 including fourteen bytes may increase the number of bits for the digital representations and/or the commands to twenty-four bits compared to sixteen bits. In another example, the packet 300 may include additional bytes that represent different types of data than described above. The packet 300 may also contain a fewer number of bytes. For example, it may contain six bytes such that it contains a single audio sample or single command, as opposed to containing two audio samples or commands.

Returning to FIG. 2, the FPGA 208 may receive the digital representations from the embedded computing device 206 (e.g., the packet 300 including the digital representations). In addition, the FPGA 208 may store the digital representations in first-in-first-out (FIFO) registers (not shown). In some embodiments, the FPGA 208 may communicate with the embedded computing device 206 in a similar manner as described above. For example, the FPGA 208 may send ten-byte packets to the embedded computing device 206.

Referring to FIG. 3, the first two bytes of the packet 300, when sent by the FPGA 208, may include FIFO statuses of each of the FIFO registers. For example, sixteen bits of the first two bytes (e.g., eight bits of the first byte and eight bits of the second byte) of the packet 300 may represent statuses of one or more FIFO registers. The status of each FIFO register may be represented by two bits. For example, a logical sequence of “01” in two bits may represent an empty register; a logical sequence of “11” may represent an almost empty register, a logical sequence of “10” may represent a normal register, or a logical sequence of “00” may represent an almost full register. The third byte through the sixth byte of the packet 300 may indicate additional information or be empty. For example, in some embodiments, four bits may be allocated for an empty counter that is incremented whenever the corresponding FIFO register goes empty, which may be repeated for up to eight FIFO registers to total four bytes of the packet 300.

In some embodiments, the seventh byte of the packet 300 may represent a counter which increments each time a checksum failure is detected. An eighth byte of the packet 300 may be a constant value used to serve as an added check to ensure that the packet 300 is not corrupted. The ninth byte of the packet 300 may include a checksum based on zone mappings to allow the embedded computing device 206 to detect whether the mapping of the FPGA 208 matches what is expected. The tenth byte of the packet 300 may be a cyclic redundancy check (CRC) generated by the nine bytes (e.g., the first byte through the ninth byte) of the packet 300.

Referring back to FIG. 2, the DSP 210 may obtain the digital representations from the FPGA 208. The DSP 210 may manipulate characteristics of the digital representations to introduce adjustments such as delay compensation, tone generation, volume adjustments, or audio mixing. For example, the DSP 210 may convert the digital representations to a different sampling rate (e.g., from 44,100 hertz (Hz) to 48,000 Hz) or sample resolution (e.g. from 16 bits to 24 bits or 32 bits). In some embodiments, the DSP 210 may manipulate different characteristics of the digital representations. For example, the DSP 210 may manipulate the equalization of the audio using graphicEQ (e.g. a plurality of fixed frequency bands for which the relative magnitudes may be adjusted), parametric EQ (e.g. the level, frequency and bandwidth Q-factor may be adjusted at a plurality of frequencies) or shelving EQ (e.g. settings to boost or cut off all frequencies above a high-shelf frequency or below a low-shelf frequency.

In some embodiments, the audio inputs from the audio sources 102 at varying data rates and/or resolutions. For example, a particular audio source (e.g., Airplay2) may provide corresponding audio input having a 44.1 KHz sample rate and 16-bit samples. The DSP 210 may be configured to manipulate or configure the data rates and/or resolutions, such that the audio data transferred from the DSP 210 to the amplifiers 212 may be configurable. For example, the DSP 210 may configure the data rates of the audio data to be 48 KHz, 96 Khz, 192 KHz, among others. Additionally or alternatively, the DSP 210 may configure the resolutions of the audio data to be 24-bit or 32-bit, among others. In some embodiments, the DSP 210 may include any suitable models or devices such as the Analog Devices ADAU1462.

The DSP 210 may manipulate the characteristics of the digital representations based on user input. For example, the audio manager 205 may communicate with a user interface on a mobile application (not shown). In some instances, the mobile application may be implemented on a mobile device such as a smartphone, tablet, among others. The user interface may allow a user to specify a manner in which the characteristics of the digital representations may be manipulated. For example, the user input may indicate that lower frequencies are to be increased to cause bass to be more pronounced. In some instances, the user input may indicate that the characteristics are to be manipulated to compensate for different zones 111a-f For example, different rooms may have different acoustic properties that may affect sound. The characteristics of the digital representations may be manipulated to compensate for such acoustic properties.

In some embodiments, the embedded computing device 206 may program the DSP 210 to perform such manipulations. For example, the embedded computing device 206 may provide commands and/or instructions to the DSP 210. In some embodiments, the embedded computing device 206 may program the DSP 210 using an inter-integrated circuit (I2C) serial interface. In these and other embodiments, the DSP 210 may correspond to a unique I2C address, such that communicating with the DSP 210 does not affect the embedded computing device 206 communicating with other I2C devices. The DSP 210 may include any suitable signal processor.

In some embodiments, the audio manager 205 may communicate with the amplifiers 212 via the data bus 211. In some embodiments, the data bus 211 may include a time-division multiplexing (TDM) bus. In some embodiments, the data bus 211 may permit the audio manager 205 to communicate with each of the amplifiers 212 using a single data bus. For example, the amplifiers 212 may be configured to listen to or obtain data from a particular time slot of the data carried by the data bus 211 that is associated with each amplifier.

Each of the amplifiers 212 may include one or more channels to permit each of the amplifiers 212 to provide audio output to multiple audio output devices 114a-f For example, the first amplifier 212a may include a first channel connected to a first audio output device 114a and a second channel connected to a second audio output device 114b. The second amplifier 212b may include a third channel connected to a third audio output device 114c and a fourth channel connected to a fourth audio output device 114d. The third amplifier 212c may include a fifth channel and a sixth channel connected to a fifth audio output device 114e and a sixth audio output device 114f, respectively. Each channel may include a left channel, a right channel, or a mono channel representing a mix of a left channel and a right channel. For example, the first channel may include a first left channel and a first right channel connected to the first audio output device 114a. In some embodiments, the audio output devices corresponding to the zones 111 may each include multiple out devices. For example, the first audio output device 114a may include a left audio output device corresponding to the left channel, and a right audio output device corresponding to the right channel. In these and other embodiments, the audio manager 205 may communicate to each channel of the amplifiers 212 through the data bus 211.

In some embodiments, the audio manager 205 may be configured to communicate with each of the amplifiers 212 via a control bus 213. Particularly, the embedded computing device 206 of the audio manager 205 may be configured to communicate with the amplifiers 212 via the control bus 213. The embedded computing device 206 may communicate control operations (e.g., control channel volume, state of the amplifiers 212 such as asleep or active, run diagnostic operations, report temperature of the amplifiers 212, etc.) to each of the amplifiers 212 via the control bus 213. In some embodiments, the embedded computing device 206 may communicate with the amplifiers 212 via a single control bus 213. For example, the embedded computing device 206 may communicate with the amplifiers 212 via a single I2C bus. ach of the amplifiers 212 may correspond to a different I2C address. This may permit the audio manager 205 to communicate with the amplifiers 212 using different I2C addresses. For example, the first amplifier 212a, the second amplifier 212b, and the third amplifier 212c may each have a unique I2C address such that the audio manager 205 can communicate to the individual amplifiers 212 using the same control bus 213. In some embodiments, the amplifiers 212 may include any suitable chips, models, and/or devices such as the Texas Instruments TAS6584.

Although FIG. 2 illustrates the audio manager 205 including the embedded computing device 206, the FPGA 208, and the DSP 120, the audio manager 205 may include more or less components. For example, in some embodiments, the audio manager 205 may not include the FPGA 208. In such instances, the embedded computing device 206 may communicate with the DSP 210, which may be configured to communicate with the amplifiers 212. Additionally or alternatively, the order of communication between the components may vary. For example, in an embodiment, the embedded computing device 206 may communicate to the DSP 210, which may communicate with the FPGA 208.

In some embodiments, the audio manager 205 may include a microcontroller configured to communicate with the embedded computing device 206. For example, the microcontroller may replace or be in addition to the FPGA 208. The microcontroller may communicate with the embedded computing device 206 via suitable communication interfaces such as universal serial bus (USB). In these and other embodiments, the microcontroller may be configured to output the signals via the TDM bus.

In some embodiments, the embedded computing device 206 may perform or take over operations described as being performed by other components. For example, although the FPGA 208 is described as mapping audio inputs to specific amplifiers 212, the embedded computing device 205 may perform such operations. For example, the embedded computing device 206 may include built-in support for the TDM bus. The embedded computing device 206 may map the audio inputs to the specific amplifiers 212 by changing which time slot each audio data belongs to or by fixing the audio inputs to different time slots and configuring the amplifiers 212 to receive data from the corresponding time slot.

The audio amplifier 106 may include a physical interface that permits the user to control the audio amplifier 106 using physical inputs. The physical interface may permit control of the audio manager 205 using the physical inputs. For example, the audio amplifier 106 may include one or more buttons configured to receive physical inputs which are converted to a format that is compatible with the audio manager 205. As an example, the audio amplifier 106 may include a reset button configured to receive and convert physical input to a reset command in a format that is compatible with the audio manager 205. Interaction with the reset button may be effective to restore the embedded computing device 206 to factory settings. For instance, any zones and/or audio sources associated with the embedded computing device 206 may be removed and/or reset based on the reset command. As another example, the audio manager 205 may include a button configured receive physical input to invoke Wi-Fi WPS on the embedded computing device 206, to cause the embedded computing device 206 to connect with a network router without an access to an interface.

In some embodiments, the audio amplifier 106 may include an external antenna (not shown) configured to improve connection range of the audio amplifier 106. For example, the external antenna may improve Wi-Fi and/or Bluetooth connectivity on a 2.4 gigahertz (GHz) and a five GHz frequency spectrum. In some embodiments, the external antenna may include any type of antenna design or model.

In some embodiments, the audio amplifier 106 may include a power source (not shown) to provide power to different parts of the audio amplifier 106. For example, the power source may provide power to the embedded computing device 206, the FPGA 208, the DSP 210, or the amplifiers 212. In some embodiments, the amplifiers 212 may include a power input port, such as an International Electrotechnical Commission 320 (IEC320) fused input connector, configured to receive power from the power source. In some embodiments, the audio amplifier 106 may receive various input voltages to power different components within the audio amplifier 106. In some embodiments, the various input voltages may include one hundred ten volts alternating current (VAC), one hundred fifteen VAC, one hundred twenty VAC, one hundred twenty five VAC, two hundred ten VAC, two hundred fifteen VAC, two hundred twenty VAC, or two hundred thirty VACc as well as other less common input voltages at a range of frequencies including fifty Hz and sixty Hz.

In some embodiments, the power source may accept direct current (DC) voltages over an operating range. For example, in some embodiments, the power source of the audio amplifier 106 may include a first power conversion circuit configured to accept various input voltages and produce one or more DC output voltages suitable for different components of the audio amplifier 106. The amplifiers 212 may accept or operate with comparatively high DC voltage source, such as twenty-four volts DC (VDC), thirty-six VDC, forty-four VDC, or more to permit the amplifiers 212 to produce high power audio signals representative of the digital representations to audio output devices, such as speakers with impedances of two, four, eight or greater Ohms. In some embodiments, the embedded computing device 206 may operate using 1.2 VDC, 3.3 VDC, or five VDC.

The audio amplifier 106 may include additional power conversion circuits configured to produce the various voltages. In some embodiments, the additional power conversion circuits may obtain a line input voltage. In other embodiments, the additional power conversion circuits may obtain intermediate voltage from the first power conversion circuit to produce the various voltages. For example, the first power conversion circuit may produce a DC output in a range of thirty-six VDC or fifty VDC. The second power conversion circuit may accept the DC output form the first power conversion circuit and produce a five VDC output, which may be used to power the embedded computing device 206. In some instances, the five VDC output may be used by a third power conversion circuit and/or a fourth power conversion circuit to produce lower output voltages such as 3.3 VDC and 1.2 VDC to power other components of the audio amplifier 106.

One or more of the amplifiers 212 may include a Class-H amplifier that is designed to improve efficiency and reduce distortion. The amplifiers 212 may dynamically adjust the power supply voltage. For instance, the amplifiers 212 may notify the power supply to adjust the voltage based on a volume level at which the amplifiers 212 are providing the audio signals. For example, in instances in which the amplifiers 212 are providing the audio signals at a lower volume level, the amplifiers 212 may operate with low output voltage and may instruct the power supply to provide a relatively low output voltage. In instances in which the amplifiers 212 are providing the audio signals at a higher volume level, the amplifiers 212 may instruct the power supply to provide increased output voltage.

Modifications, additions, or omissions may be made to the audio amplifier 106 without departing from the scope of the present disclosure. For example, in some embodiments, the audio amplifier 106 may include any number of other components that may not be explicitly illustrated or described.

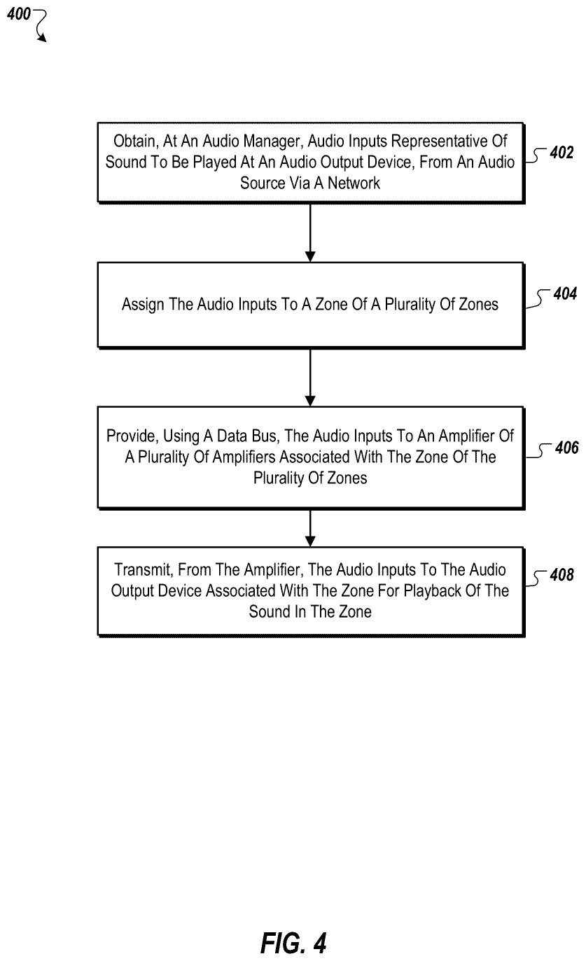

FIG. 4 illustrates a flow chart of an example method 400 of routing different audio inputs to audio zones, arranged in accordance with at least one embodiment of the present disclosure. One or more operations of the method 400 may be implemented by any suitable element of a multi-zone audio amplifier such as the multi-zone amplifier 106 of FIGS. 1 and 2. Although illustrated as discrete steps, various steps of the method 400 may be divided into additional steps, combined into fewer steps, or eliminated, depending on the desired implementation. Additionally, the order of performance of the different steps may vary depending on the desired implementation.

In some embodiments, the method 400 may include a block 402. At block 402, an audio manager may obtain audio inputs representative of sound to be played at an audio output device from an audio source via a network. In some embodiments, the audio manager may correspond to the audio manager 205 of FIG. 2. In some embodiments, the audio source may include one or more devices that may store and/or generate the audio inputs to be transmitted to the audio manager. For example, the audio sources may include tablets, computers, smart phones, among others. In some embodiments, the audio manager may obtain the audio inputs from the audio sources in a concurrent or substantially simultaneous manner.

At block 404, the audio manager may assign the audio inputs to a zone of a set of zones based on the audio source. The set of zones may include different zones that the audio manager or the multi-zone audio amplifier may be associated with. The audio inputs may be assigned to the zone such that the audio inputs may be played as sound output using an audio output device or audio output devices at the zone. In some embodiments, the audio inputs may be assigned to multiple zones of the set of zones.

At block 406, the audio manager may provide, using a data bus, the audio inputs to an amplifier of a set of amplifiers associated with the zone of the set of zones. In some embodiments, the set of amplifiers may be configured to provide the audio inputs to different zones. In some embodiments, the set of amplifiers may correspond to the amplifiers 212 of FIG. 2. In some embodiments, the audio manager may be configured to communicate with the set of amplifiers via the same data bus. For example, the data bus may carry messages and/or data for each of the amplifiers at the same time, in which each amplifier of the set of amplifiers are configured to only receive the message and/or the data sent for each amplifier. In some embodiments, each amplifier may also use an I2c bus and be associated with a unique I2C address, such that the audio manager may distinguish between the amplifiers. In some embodiments, the data bus may correspond to the data bus 211 of FIG. 2.

At block 408, the amplifier may transmit the audio inputs to the audio output device associated with the zone for playback of the sound in the zone. For example, the audio output device may audibly play the sound corresponding to the audio inputs. In some embodiments, a particular amplifier may be associated with multiple zones and/or multiple audio output devices. For example, the particular amplifier may include multiple channels for which the multiple channels are associated with different zones or audio output devices.

Modifications, additions, or omissions may be made to the method 400 without departing from the scope of the present disclosure. For example, one skilled in the art will appreciate that, for this and other processes, operations, and methods disclosed herein, the functions and/or operations performed may be implemented in differing order. Furthermore, the outlined functions and operations are only provided as examples, and some of the functions and operations may be optional, combined into fewer functions and operations, or expanded into additional functions and operations without detracting from the essence of the disclosed embodiments.

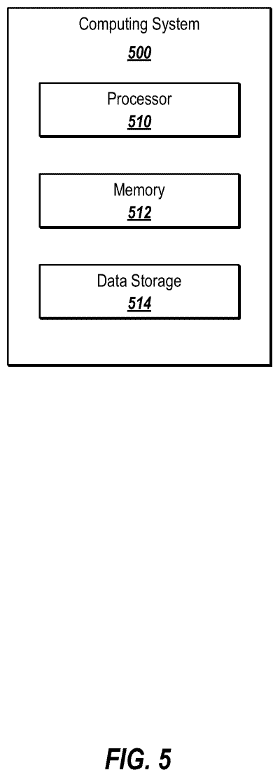

FIG. 5 illustrates a block diagram of an example computing system 500 that may be used with the multi-zone audio amplifier of FIGS. 1 and 2, according to at least one embodiment of the present disclosure. For example, the computing system 500 may correspond to the audio manager 205, the embedded computing device 206, the FPGA 208, or the DSP 210 FIG. 2.

The computing system 500 may include a processor 510, a memory 512, and a data storage 514. The processor 510, the memory 512, and the data storage 514 may be communicatively coupled.

In general, the processor 510 may include any suitable special-purpose or general-purpose computer, computing entity, or processing device including various computer hardware or software modules and may be configured to execute instructions stored on any applicable computer-readable storage media. For example, the processor 510 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. Although illustrated as a single processor in FIG. 5, the processor 510 may include any number of processors configured to, individually or collectively, perform or direct performance of any number of operations described in the present disclosure. Additionally, one or more of the processors may be present on one or more different electronic devices, such as different servers.

In some embodiments, the processor 510 may be configured to interpret and/or execute program instructions and/or process data stored in the memory 512, the data storage 514, or the memory 512 and the data storage 514. In some embodiments, the processor 510 may fetch program instructions from the data storage 514 and load the program instructions in the memory 512. After the program instructions are loaded into memory 512, the processor 510 may execute the program instructions.

The memory 512 and the data storage 514 may include computer-readable storage media for carrying or having computer-executable instructions or data structures stored thereon. Such computer-readable storage media may include any available media that may be accessed by a general-purpose or special-purpose computer, such as the processor 510. By way of example, and not limitation, such computer-readable storage media may include tangible or non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to store particular program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 510 to perform a certain operation or group of operations.

Modifications, additions, or omissions may be made to the computing system 500 without departing from the scope of the present disclosure. For example, in some embodiments, the computing system 500 may include any number of other components that may not be explicitly illustrated or described.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. Additionally, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B” even if the term “and/or” is used elsewhere.

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure.

What is claimed is:

1. A multi-zone audio amplifier comprising:
an audio manager configured to obtain audio inputs representative of sound to be played at an audio output device, from an audio source via a network;
a data bus coupled to the audio manager;
a plurality of amplifiers coupled to the data bus, the plurality of amplifiers configured to:
provide audio outputs representative of the sound to a plurality of zones, each zone of the plurality of zones corresponding to one or more different audio output devices for playback of the sound; and
receive the audio inputs from the audio manager via the data bus.

2. The multi-zone audio amplifier of claim 1, wherein the data bus includes a time-division multiplexed (TDM) bus.

3. The multi-zone audio amplifier of claim 2, wherein the TDM bus supports sixteen channels of audio.

4. The multi-zone audio amplifier of claim 1, wherein each amplifier of the plurality of amplifiers is configured to provide the audio inputs to a different zone of the plurality of zones.

5. The multi-zone audio amplifier of claim 1, wherein the audio manager is configured to obtain the audio inputs from a plurality of audio sources concurrently.

6. The multi-zone audio amplifier of claim 5, wherein a plurality of audio sources includes at least one of a wired device or a wireless device.

7. The multi-zone audio amplifier of claim 1, wherein the audio manager comprises:
an embedded computing device configured to obtain the audio inputs from the audio source.

8. The multi-zone audio amplifier of claim 7, wherein the embedded computing device includes at least one of: a microprocessor, a microcontroller, a FPGA, or a DSP.

9. The multi-zone audio amplifier of claim 7, wherein the embedded computing device includes a plurality of processors linked together to facilitate distribution and processing of the audio inputs.

10. The multi-zone audio amplifier of claim 7, wherein the embedded computing device is configured to further communicate the audio inputs using a serial communication bus.

11. The multi-zone audio amplifier of claim 7, wherein the audio manager further comprises a field programmable gate array (FPGA) configured to obtain the audio inputs from the embedded computing device, the FPGA configured to transmit the audio inputs using the data bus.

12. The multi-zone audio amplifier of claim 11, wherein the embedded computing device is configured to communicate to the FPGA using a serial peripheral interface (SPI) bus.

13. The multi-zone audio amplifier of claim 11, wherein the embedded computing device is configured to communicate to the FPGA using a packet, wherein the packet contains at least one of data or commands for the FPGA.

14. The multi-zone audio amplifier of claim 13, wherein the packet is of 10-bytes length.

15. The multi-zone audio amplifier of claim 14, wherein a first byte of the packets includes a header characterizing a second byte through a ninth byte of the packets.

16. The multi-zone audio amplifier of claim 14, wherein a tenth byte of the packets includes a checksum representing error detection of communication of the packets.

17. The multi-zone audio amplifier of claim 11, wherein the audio manager further comprises:
a digital signal processor (DSP) coupled to the FPGA and coupled to the plurality of amplifiers, the DSP configured to manipulate characteristics of the audio inputs to introduce adjustments to the sound played at the audio output device.

18. The multi-zone audio amplifier of claim 17, wherein the characteristics include data rates and resolutions of the audio inputs.

19. The multi-zone audio amplifier of claim 1, wherein each amplifier of the plurality of amplifiers is assigned a different inter-integrated circuit (I2C) address to permit the audio manager to individually communicate, via data control bus, with each amplifier of the plurality of amplifiers.

20. The multi-zone audio amplifier of claim 1, further comprising:
a power supply configured to receive varying input voltages.

21. The multi-zone audio amplifier of claim 1, wherein at least one amplifier of the plurality of amplifiers is a Class-H amplifier configured to control input voltage provided to the one amplifier.

22. A method comprising:
obtaining, at an audio manager, audio inputs representative of sound to be played at an audio output device, from an audio source via a network;
assigning the audio inputs to a zone of a plurality of zones;
providing, using a data bus, the audio inputs to an amplifier of a plurality of amplifiers associated with the zone of the plurality of zones; and
transmitting, from the amplifier, the audio inputs to the audio output device associated with the zone for playback of the sound in the zone.
